(19) United States
(12) Patent Application Publication
(10) Pub. No.: US 2026/0365327 A1
(43) Pub. Date: Nov. 19, 2026

(54) SPIRAL SPACE HABITAT WITH INTEGRATED THERMAL REGULATION AND ECOSYSTEM

(71) Applicant: Timothy P. Barber, Miami, FL (US)

(72) Inventor: Timothy P. Barber, Miami, FL (US)

(21) Appl. No.: 19/673,261

(22) Filed: May 11, 2026

Related U.S. Application Data
(60) Provisional application No. 63/808,454, filed on May 19, 2025.

(51) Int. Cl. B64G 1/12; B64G 1/10; B64G 1/24; B64G 1/34; B64G 1/46; B64G 1/50; B64G 1/60; B64G 1/66; E02B 3/00

(52) U.S. Cl. CPC B64G 1/12; B64G 1/1085; B64G 1/2429; B64G 1/34; B64G 1/465; B64G 1/503; B64G 1/60; B64G 1/66; E02B 3/00

(57) ABSTRACT

Techniques and apparatuses for operating a space habitat are provided. An example space habitat includes (i) a continuously habitable pressure vessel extending in a spiral configuration about a rotation axis, where rotation of the space habitat around the rotation axis produces a gravity gradient along the spiral configuration from a central region of the vessel to an outer region of the vessel; (ii) a circulating gravity-driven river system extending along at least a portion of the spiral configuration; and (iii) a heat rejection system configured to receive water from a terminal portion of the river system, circulate the water through external radiators, and return cooled water to an inlet portion of the river system.

### CROSS-REFERENCE TO RELATED APPLICATION(S)

The present application claims the benefit of and priority to U.S. Provisional Patent Application No. 63/808,454, filed May 19, 2025, which is expressly incorporated by reference herein in its entirety as if fully set forth below and for all applicable purposes.

### TECHNICAL FIELD

Embodiments of the present disclosure generally relate to space habitats and, more particularly, to space habitats with integrated thermal regulation and ecosystem.

### BACKGROUND

Space habitats are orbital or deep space structures designed to support permanent or long-term human habitation beyond Earth. These habitats aim to provide the essential conditions for human life, including artificial gravity generated through rotation, breathable atmosphere, temperature control, radiation protection, and sustainable life support systems. As humanity contemplates extended missions to distant locations in the solar system and the establishment of permanent settlements in space, the development of large-scale habitats capable of sustaining human populations for extended periods has become an important area of research and engineering.

Modern research into large-scale space habitats is informed by a long history of conceptual exploration of rotating structures intended to support human life in space. Prior work has proposed a variety of habitat geometries, including wheel-shaped, spherical, toroidal, and cylindrical configurations, each leveraging rotation to generate artificial gravity through centripetal force. These concepts have been explored in both theoretical and engineering contexts, often incorporating enclosed ecosystems, habitable internal surfaces, and large structural spans designed for sustained human occupancy.

### SUMMARY

While rotating cylindrical habitat geometries proposed in prior work are conceptually compelling, such configurations exhibit significant engineering and operational limitations. A rotating cylindrical body exhibits a rod-like mass distribution whose principal moments of inertia may place the structure in a dynamically unstable rotational regime, which involves using continuous active stabilization and precise mass balancing to prevent tumbling. Structurally, hoop stress increases with radius, causing wall thickness and structural mass per unit of habitable area to increase sharply as habitat size increases. Because substantially all habitable land area lies adjacent to the outer hull, extensive radiation shielding must generally be provided over the entire exterior surface. Additionally, the habitable surface is generally flat, with the curved hull arching overhead, providing limited natural topographic variation without introducing additional mass and potential rotational imbalance. No natural head-pressure gradient exists within such configurations, such that all water transport should be pump-driven, limiting surface hydrology to shallow bodies rather than sustained river systems. Waste heat naturally migrates toward the rotational axis and must be actively collected and transported to external radiators. Atmospheric circulation and precipitation likewise do not arise naturally, leaving airflow, humidity regulation, and rainfall entirely dependent on large mechanical systems. These limitations motivate the present disclosure, which addresses such structural, thermal, hydrological, and habitability challenges through a spiral geometry that integrates passive inertial stability, reduced structural mass, self-shielding, and natural hydrologic and atmospheric circulation within a unified habitat design.

Designing a space habitat capable of supporting large-scale, long-duration human habitation presents significant challenges in thermal regulation, structural stability, and ecological diversity. Embodiments described herein leverage the rotational dynamics of a spiral-shaped habitat body to simultaneously generate a gravity gradient, drive passive thermal regulation, and establish a continuously habitable structure supporting diverse ecological and residential zones within a single integrated design. The spiral configuration enables a water circulation system in which thermal energy can be collected and transported from a central core region to an outer rim region by gravity-driven flow, where a thermal rejection system can expel the collected thermal energy to the external environment through external radiators and return cooled liquid to the central core region. A notable emergent property of the spiral geometry is that the river system can flow at constant speed throughout the length of the spiral, as gravitational acceleration and terrain slope cancel out, yielding constant head pressure along the entire channel. These and other features described herein enable a spiral space habitat that overcomes the mechanical, thermal, and habitability limitations of conventional designs by integrating passive gravity-driven thermal transport with a closed ecological cycle within a structurally stable, continuously habitable spiral structure.

Embodiments of the present disclosure provide a rotating spiral habitat that may provide a continuous artificial-gravity gradient from a central core to an outer rim, ranging from approximately 0.3 g at the core to 1.0 g at the outer rim. A river system may run the length of the spiral, serving simultaneously as ecological substrate, hydrological feature, and thermal transport medium. Heat absorbed by the river may be rejected to space through external radiators before cooled water is reinjected near the core. Natural atmospheric circulation may arise from buoyancy driven by the river's temperature gradient, producing a prevailing downhill breeze. This airflow may enable a precipitation system to produce controlled rainfall synchronized with the prevailing wind, for irrigation, humidity control, fire suppression, and air scrubbing. Light-emitting diode (LED) lighting fixtures may transfer heat to a secondary, higher-temperature side-ejection radiator loop, supplementing the primary thermal rejection system. One or more elevator systems may provide radial transport shortcuts between different points along the spiral. The spiral geometry may yield passive inertial stability, reduced structural tendon mass, reduced shielding demands, natural hydrologic and atmospheric circulation, and functional zoning by gravity level, including forest, farm, and town zones, making the spiral a scalable, mass-efficient, and ecologically robust evolution of classical cylindrical designs. In some embodiments, a plurality of such habitats may co-orbit a celestial body, forming a propellant-free cargo relay network.

Viewed from the exterior, the habitat can present a puck-like form factor, similar in profile to a spool of ribbon, a jelly-roll, or a snail shell. Viewed from within, the habitable interior presents as a mile-wide river valley over one hundred miles long, with an artificial sky approximately one hundred meters overhead and terrain gently curving out of sight in each direction. Key design parameters include habitat radius (R), valley width (T), coil constant (σ), deck spacing (R/σ), minimum gravity (μ), river velocity (v), river temperature gradient (ΔT), and rim flat-cycle fraction (z).

Embodiments of the present disclosure provide a space habitat. The space habitat includes a continuously habitable pressure vessel extending in a spiral configuration about a rotation axis, rotation of the space habitat around the rotation axis producing a gravity gradient along the spiral configuration from a central region of the vessel to an outer region of the vessel, a circulating gravity-driven river system extending along at least a portion of the spiral configuration, and a heat rejection system configured to receive water from a terminal portion of the river system, circulate the water through external radiators, and return cooled water to an inlet portion of the river system.

In some embodiments, which may be combined with any one or more embodiments described herein, a local slope of the river system varies approximately inversely with local distance from the rotation axis, thereby offsetting a radial variation in local artificial gravity, resulting in near constant head pressure and substantially uniform river speed throughout the spiral configuration.

In some embodiments, which may be combined with any one or more embodiments described herein, the gravity gradient optionally increases along the spiral configuration from the central region to between 0.9 g and 1.1 g at the outer region.

In some embodiments, which may be combined with any one or more embodiments described herein, the vessel optionally has a thickness measured parallel to the rotation axis and a radius measured from the rotation axis to an outermost point of the vessel, the thickness ranging from ⅓ of the radius to ⅔ of the radius.

In some embodiments, which may be combined with any one or more embodiments described herein, the external radiators are positioned on an exterior surface of the space habitat configured for shadow-side heat rejection.

In some embodiments, which may be combined with any one or more embodiments described herein, the river system optionally comprises a plurality of river channels arranged helically.

In some embodiments, which may be combined with any one or more embodiments described herein, the plurality of river channels are optionally separated by islands configured to support housing.

In some embodiments, which may be combined with any one or more embodiments described herein, the plurality of river channels are optionally separated by islands configured to support vegetation.

In some embodiments, which may be combined with any one or more embodiments described herein, the plurality of river channels are optionally separated by islands configured to support pathways.

In some embodiments, which may be combined with any one or more embodiments described herein, the plurality of river channels are optionally separated by islands configured to support ecological features.

In some embodiments, which may be combined with any one or more embodiments described herein, the space habitat optionally further comprises a water reclamation segment located near the outer region and configured to treat the water from the river system before the water enters the heat rejection system.

In some embodiments, which may be combined with any one or more embodiments described herein, the space habitat optionally further comprises a precipitation system configured to produce controlled rainfall sourced from the river system.

In some embodiments, which may be combined with any one or more embodiments described herein, the space habitat optionally further comprises one or more elevator systems providing radial transport shortcuts through the space habitat between different points along the spiral configuration.

In some embodiments, which may be combined with any one or more embodiments described herein, the vessel is optionally divided into functional zones based on local gravity levels, including a forest zone having a gravity level between 0.3 g and 0.6 g, a farm zone having a gravity level between 0.6 g and 0.75 g, and a town zone having a gravity level between 0.75 g and 1.0 g.

In some embodiments, which may be combined with any one or more embodiments described herein, lighting is optionally provided by LED fixtures configured to transfer heat to a secondary, higher-temperature side-ejection radiator loop.

Embodiments of the present disclosure provide a space habitat system. The space habitat system includes a plurality of space habitats co-orbiting a celestial body, each space habitat of the plurality of space habitats comprising a continuously habitable pressure vessel extending in a spiral configuration about a rotation axis, rotation of the space habitat around the rotation axis producing a gravity gradient along the spiral configuration from a central region of the vessel to an outer region of the vessel, a circulating gravity-driven river system extending along at least a portion of the spiral configuration, and a heat rejection system configured to receive water from a terminal portion of the river system, circulate the water through external radiators, and return cooled water to an inlet portion of the river system.

In some embodiments, which may be combined with any one or more embodiments described herein, the plurality of space habitats optionally form a propellant-free cargo relay network.

Embodiments of the present disclosure provide a rotating space habitat. The rotating space habitat includes a spiral configuration generating a smooth gradient of artificial gravity between a central core and an outer rim, a river system flowing along a length of the spiral configuration, configured for ecosystem support and acting as a primary medium for capturing and transporting internal habitat heat, and a radiator system thermally coupled to the river system, configured to receive heated water from near the outer rim, reject captured heat to space, and return cooled water to the river system near the central core.

In some embodiments, which may be combined with any one or more embodiments described herein, the spiral configuration optionally completes approximately 12 to 24 revolutions, establishing an artificial gravity gradient ranging from 0.3 g at the central core to 1.0 g at the outer rim.

In some embodiments, which may be combined with any one or more embodiments described herein, the rotating space habitat optionally further comprises a habitable valley having a width that is constrained to less than or equal to a radius/1.5, ensuring a thin-puck inertial distribution that is passively stable against tumbling.

In some embodiments, which may be combined with any one or more embodiments described herein, the rotating space habitat optionally further comprises a precipitation system configured to produce controlled rainfall synchronized with prevailing atmospheric circulation.

In some embodiments, which may be combined with any one or more embodiments described herein, the rotating space habitat optionally further comprises one or more elevator systems providing radial transport shortcuts through the rotating space habitat between different points along the spiral configuration.

In some embodiments, which may be combined with any one or more embodiments described herein, a structure of the rotating space habitat is optionally divided into functional zones based on local gravity levels, including a forest zone having a gravity level between 0.3 g and 0.6 g, a farm zone having a gravity level between 0.6 g and 0.75 g, and a town zone having a gravity level between 0.75 g and 1.0 g.

In some embodiments, which may be combined with any one or more embodiments described herein, lighting is optionally provided by LED fixtures, transferring heat to a secondary, higher-temperature side-ejection radiator loop.

Embodiments of the present disclosure are directed to a method of operating a space habitat. The method includes rotating a habitable pressure vessel extending in a spiral configuration about a rotation axis to produce a gravity gradient along the spiral configuration; circulating water through a gravity-driven river system extending along at least a portion of the spiral configuration; receiving, by a heat rejection system, water from a terminal portion of the river system; circulating the water through external radiators; and returning cooled water to an inlet portion of the river system near the central region.

Embodiments of the present disclosure are directed to a method of operating a space habitat. The method includes rotating a habitable pressure vessel extending in a spiral configuration about a rotation axis to produce a gravity gradient along the spiral configuration; circulating water through a gravity-driven river system extending along at least a portion of the spiral configuration; receiving water from a terminal portion of the river system; expelling thermal energy through external radiators; and returning cooled water to an inlet portion of the river system near the central region.

Some embodiments of the present disclosure include corresponding methods and apparatus according to any of the features described herein.

### BRIEF DESCRIPTION OF THE DRAWINGS

Having thus described the inventions in general terms, reference will now be made to the accompanying drawings, which are not necessarily drawn to scale, and wherein:

FIG. 1A is a planetary system with a celestial body and a space habitat, in accordance with some embodiments of the present disclosure.

FIG. 1B is an example planetary system with the celestial body and multiple space habitats, in accordance with some embodiments of the present disclosure.

FIG. 1C is an example planetary system with the celestial body and multiple space habitats in different orbits, in accordance with some embodiments of the present disclosure.

FIG. 1D is an example planetary system with the celestial body and multiple space habitats illustrating a transfer mechanism, in accordance with some embodiments of the present disclosure.

FIG. 2A is an exterior view of the example space habitat, in accordance with some embodiments of the present disclosure.

FIG. 2B is a cutaway view of the example space habitat, in accordance with some embodiments of the present disclosure.

FIG. 2C is a side cut-away view of the example space habitat, in accordance with some embodiments of the present disclosure.

FIG. 2D is a cross-section view of the example space habitat, in accordance with some embodiments of the present disclosure.

FIG. 3 is an example water circulation system of the example space habitat, in accordance with some embodiments of the present disclosure.

FIG. 4 is a flow diagram of example operations for a space habitat, in accordance with some embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present disclosure generally relate to space habitats and, more particularly, to space habitats with integrated thermal regulation and ecosystem. More particularly, embodiments described herein provide a space habitat that may include a continuously habitable pressure vessel extending in a spiral configuration about a rotation axis, wherein rotation of the space habitat about the rotation axis may produce a gravity gradient along the spiral configuration from a central region of the vessel to an outer region of the vessel. The space habitat may further include a circulating gravity-driven river system extending along at least a portion of the spiral configuration and a heat rejection system configured to receive water from a terminal portion of the river system, circulate the water through external radiators, and return cooled water to an inlet portion of the river system.

Various embodiments of the disclosure are described more fully hereinafter with reference to the accompanying drawings. This disclosure may, however, be embodied in many different forms and should not be construed as limited to any specific structure or function presented throughout this disclosure. Rather, these embodiments are provided so that this disclosure will be thorough and complete, and will fully convey the scope of the disclosure to those skilled in the art. Based on the teachings herein one skilled in the art should appreciate that the scope of the disclosure is intended to cover any embodiment of the disclosure disclosed herein, whether implemented independently of or combined with any other embodiment of the disclosure. For example, an apparatus may be implemented or a method may be practiced using any number of the embodiments set forth herein. In addition, the scope of the disclosure is intended to cover such an apparatus or method which is practiced using other structure, functionality, or structure and functionality in addition to or other than the various embodiments of the disclosure set forth herein. It should be understood that any embodiment of the disclosure disclosed herein may be embodied by one or more elements of a claim.

### Historical Background

The concept of large rotating habitats in space has a clear intellectual lineage spanning nearly a century. The first serious proposal came from Hermann Potočnik in 1929, who described a rotating wheel-shaped station designed to generate artificial gravity by centripetal force [1]. In the same year, John Desmond Bernal introduced the concept of a spherical settlement enclosing an ecosystem, later known as the “Bernal Sphere” [2]. In the 1950s, Wernher von Braun popularized a toroidal (wheel) station design through his Collier's magazine series and later technical compilations [3]. This design linked public imagination to sketches with a genuine engineering basis.

A generation later, Arthur C. Clarke provided one of the most vivid and widely cited depictions of a rotating cylindrical habitat in his 1973 novel Rendezvous with Rama [4]. Although fiction, Clarke's credibility as the originator of the geostationary satellite concept [4] ensured that the cylinder entered serious discourse as a possible geometry.

Finally, in 1974, Gerard K. O'Neill reframed all of these geometries in his Physics Today article, “The Colonization of Space” [5]. This work was followed by the NASA Ames/Stanford Summer Study (1975), published as Space Settlements: A Design Study (NASA SP-413) [6], which analyzed geometric design, artificial gravity, thermal balance, structural standards, and ecological closure. These studies remain the most authoritative engineering treatment of rotating habitats to date.

Subsequent efforts include O'Neill's popular book The High Frontier [7], the Kalpana One design [8], studies of natural illumination [9], structural pressure vessels [10], and large-scale scaling concepts such as the McKendree Cylinder [11]. These later works function more as refinements or subsystem explorations than as comprehensive engineering baselines.

### The Engineering Problem

While the cylinder geometry is conceptually compelling, it exhibits significant engineering limitations:

Stability. A rotating cylinder has a rod-like mass distribution. Its principal moments of inertia (I_long<I_med<I_short) place it in the unstable Dzhanibekov regime. Continuous active stabilization and precise mass balancing may be utilized to prevent tumbling.

Scaling. A pressurized cylinder of radius R behaves structurally like a suspension bridge of span R. Hoop stress increases in proportion to R, forcing wall thickness to scale upward. As a result, the structural mass per unit of habitable floor area increases sharply with radius.

Shielding. All land area lies adjacent to the hull. After adding soil for agriculture, approximately one meter of water-equivalent shielding may be utilized to reduce cosmic radiation by a factor of 5000, from ~25 mSv/day to Earthlike ~5 μSv/day.

Terrain. The habitat floor is flat, with the curved ceiling arcing overhead. The “curved Kansas” effect. Any varied topography adds mass and risks unbalancing the rotation.

Hydrology. No natural head-pressure gradient exists. All water flow is generally pump-driven, yielding shallow ponds rather than true rivers.

Cooling. Waste heat rises toward the axis, where it is generally actively collected and transported to endcap radiators.

Airflow. No natural atmospheric circulation occurs. Air is generally ducted or moved mechanically by large fans.

Rain. Infrastructure for natural rainfall is absent. Precipitation is generally simulated by artificial systems.

Oxygen. Atmospheric scrubbing is generally performed mechanically, adding maintenance overhead.

Transit. Flat-surface transit is possible. No direct shortcuts exist between points, as all movement is constrained to the cylindrical surface.

These limitations motivate the present embodiments, solving all of these issues with a spiral geometry, and eliminating excessive machinery or heroic subsystems.

### Summary of the Embodiments

Embodiments described herein provide a rotating spiral habitat that wraps the habitable surface helically around the spin axis, producing a continuous artificial-gravity gradient from approximately 0.3 g near the core to 1.0 g at the rim. In some cases, a river system runs the length of the spiral. Cool water enters at the top (near the core) and collects heat as it flows downhill at constant speed. At the rim, warmed water is transported to shadow-side radiators, and cooled water reinjected near the core. Atmospheric circulation arises naturally from buoyancy, producing a prevailing downhill breeze and enabling schedulable rainfall.

Outside we see a puck-like form factor, similar to a spool of ribbon, a jelly-roll, or a snail shell. Inside we see a mile-wide river valley, over a hundred miles long, with artificial sky a hundred meters overhead, and the land gently curving out of sight a mile away in each direction.

Parameters can include: habitat radius (R), valley width (τ), coil constant (σ), deck spacing (R/σ), min gravity (μ), river velocity (v), river gradient (ΔT), and flat cycle fraction (z).

Example Operating ranges:
Radius: R=454 m-4,540 m
Valley width: τ=⅓ R-⅔ R
Coil constant: σ=15-30
Deck spacing: R/σ=30 m-100 m
Min gravity: μ=30%-50% (of Earth normal 1.0 g)
Rim gravity: 100%
River speed: v=0.5-0.7 m/s (≈0.6 ideal in some cases)
River heat sink: ΔT=10-15° C. (≈12 ideal in some cases)
Rim flat cycle fraction: z=~75%

### Example Cylinder vs Spiral Area Comparison:

Cylinder floor area=50 R²=2πR×8 R for length=8 R.
Spiral floor area=50 R² for σ=30, τ=R/1.8, z=0.75, μ=0.30.
=τ(πR² (1.0²-μ²)/(R/σ)+2πRz).
Spiral floor area=50 R² for σ=30, τ=R/1.5, z=0.75, μ=0.50.
=τ(πR² (1.0²-μ²)/(R/σ)+2πRz)
   Example Sample scaling:
Radius→Land Area→River Valley length
1140 m/0.7 mi→65 km²/25 mi²→103 km/64 mi
1610 m/1.0 mi→130 km²/50 mi²→166 km/90 mi
2270 m/1.4 mi→260 km²/100 mi²→206 km/128 mi
3220 m/2.0 mi→515 km²/200 mi²→290 km/180 mi
4540 m/2.8 mi→1036 km²/400 mi²→414 km/257 mi

In some embodiments, we have:
Radius R=2270 m≈1.4 mi
Valley width R/1.8=τ≈1260 m≈4140′≈0.78 mi
Coil constant σ=30 (sets river speed)
River gradient ΔT=12° C. (sets wind speed)

From these, we obtain:
Deck spacing R/σ≈76 m≈250′ (ideal, in some cases, for air flow and canopy)
Rim speed=150 m/s (ideal, in some cases, for rim-to-rim cargo transfer)
River speed v=0.6 m/s≈1.34 mph (ideal, in some cases, for river ecosystem)
River “float trip” time=4.0 days
Wind speed w=2.5 m/s≈5.6 mph (downhill breeze)
Air pressure (rim)=0.89 atm≈Earth at 900 m
Air pressure (forest)=0.79 atm≈Earth at 2000 m
Land area=260 km²≈100 mi² (ideal, in some cases, for city/farm/forest scale)
Population=100,000-1,000,000
Land/person≈2600 m²-260 m²

### Example Space Habitats

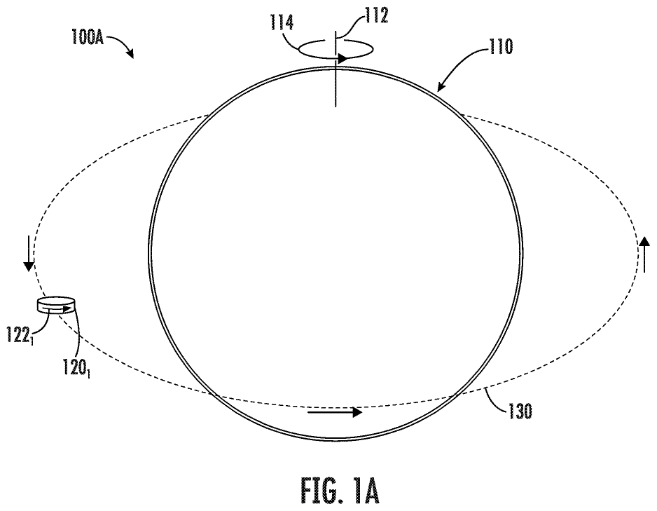

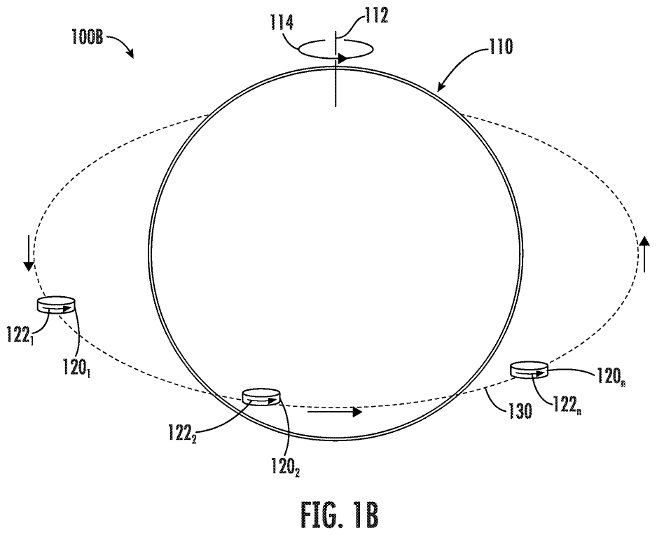

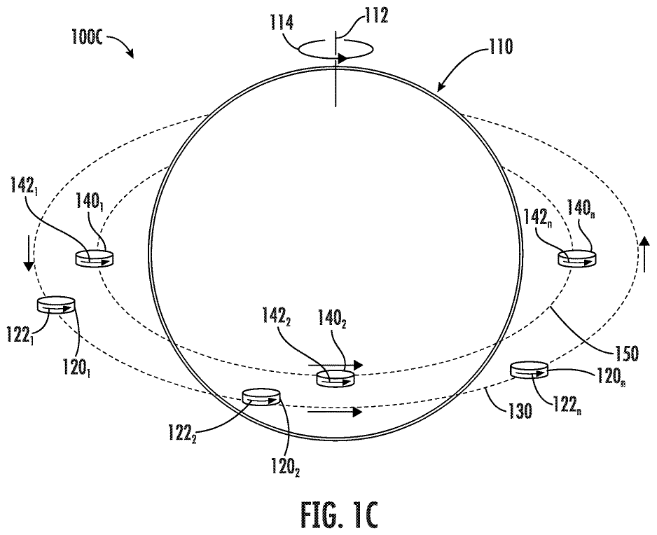

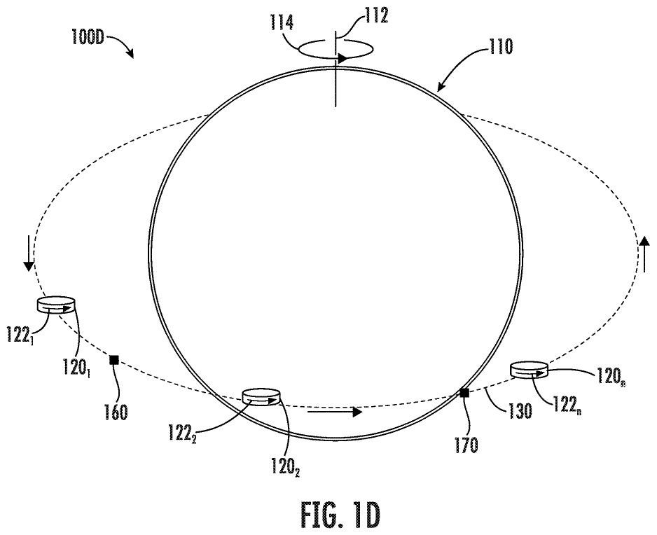

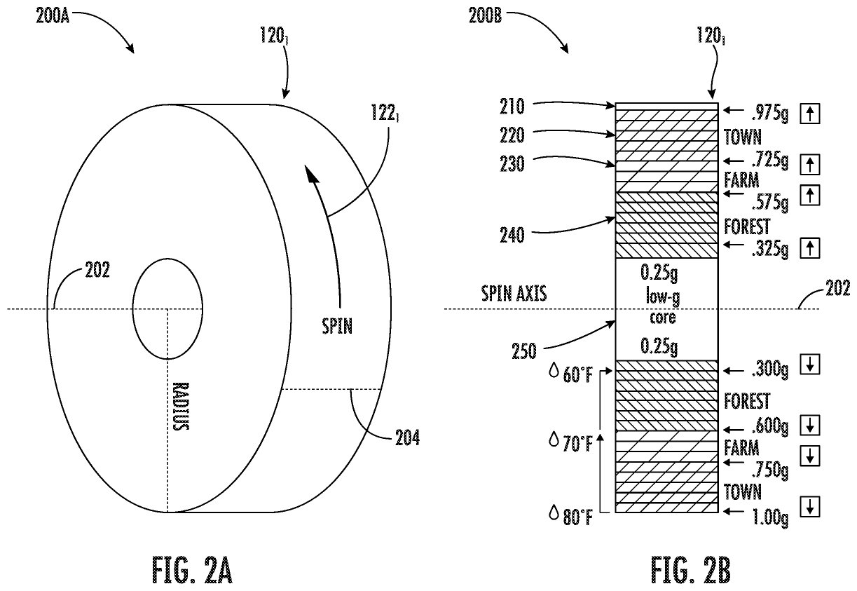

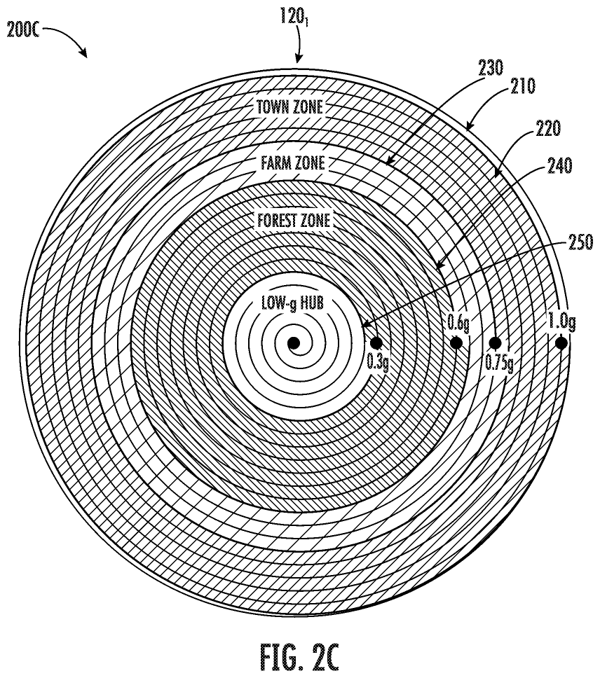

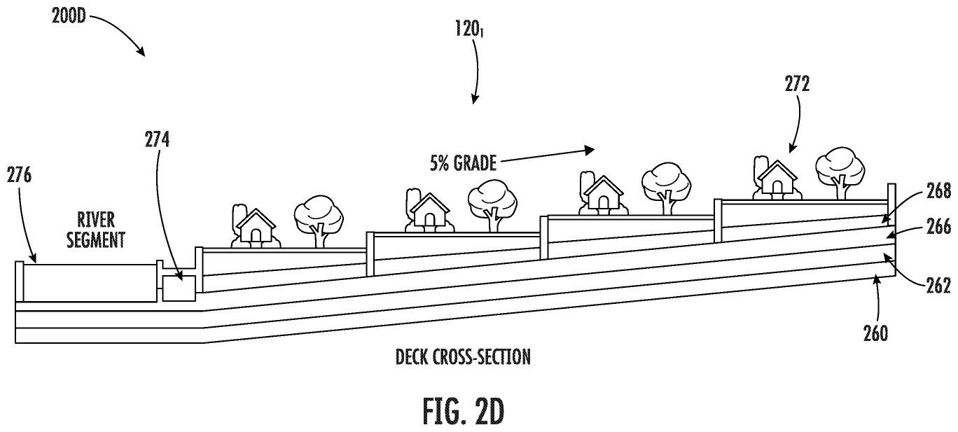

FIG. 1A is a planetary system 100A with a celestial body 110 and a space habitat 120₁, in accordance with some embodiments of the present disclosure. The celestial body 110 can have an axis of rotation 112 and a rotation direction 114, with the space habitat 120₁ disposed in an orbit 130 about the celestial body 110. The space habitat 120₁ may rotate in a rotation direction 122₁, generating an artificial gravity gradient within the space habitat 120₁ from a central low-gravity region to an outer higher-gravity region, as further illustrated in FIG. 2A-2C. In some embodiments, the space habitat 120₁ may take the form of a continuously habitable pressure vessel extending in a spiral configuration that completes approximately 12 to 24 revolutions about a spin axis 202, establishing an artificial gravity gradient ranging from approximately 0.3 g at a central core to approximately 1.0 g at an outer rim. The orbit 130 may correspond to an equatorial orbit about the celestial body 110.
FIG. 1B is an example planetary system 100B with the celestial body 110 and multiple space habitats 120₁, 120₂, and 120ₙ, in accordance with some embodiments of the present disclosure. The space habitats 120₁, 120₂, and 120ₙ can co-orbit the celestial body 110 in the orbit 130, each space habitat rotating about the spin axis 202 in a respective rotation direction 122₁, 122₂, 122ₙ. The number of co-orbiting space habitats in the orbit 130 may range from two to any number n, depending on the orbital capacity and mission parameters of the deployment. Each space habitat 120₁ through 120ₙ may include a river system in which downhill flow is driven by the gravity gradient produced by rotation, and a heat rejection system configured to receive warmed water from the river system, reject heat through external radiators, and return cooled water to an upstream inlet portion of the river system.

FIG. 1C is an example planetary system 100C with the celestial body 110 and multiple space habitats 120₁, 120₂, 120 ₙ, 140₁, 140₂, and 140ₙ in different orbits, in accordance with some embodiments of the present disclosure. The planetary system 100C may include a first set of space habitats 120₁, 120₂, through 120ₙ disposed in the orbit 130, each rotating in respective rotation directions 122₁, 122₂, 122ₙ, and a second set of space habitats 140₁, 140₂, through 140ₙ disposed in an orbit 150, each rotating in respective rotation directions 142₁, 142₂, 142ₙ. The orbit 130 and the orbit 150 may be distinct orbital paths about the celestial body 110, each oriented relative to the axis of rotation 112 of the celestial body 110. In some embodiments, the orbit 130 and the orbit 150 may correspond to orbital rings at different altitudes, with an innermost ring servicing surface transport operations and an outermost ring supporting inter-habitat construction and logistics. Each space habitat 120₁ through 120ₙ and 140₁ through 140ₙ may include one or more elevator systems providing radial transport shortcuts between different gravity zones within the respective space habitat.

FIG. 1D is an example planetary system 100D with the celestial body 110 and multiple space habitats 120₁, 120₂, and 120ₙ illustrating a transfer mechanism, in accordance with some embodiments of the present disclosure. The planetary system 100D may include cargo 160 and cargo 170 in transit between the space habitats 120₁ and 120₂ co-orbiting in the orbit 130 about the celestial body 110, with each space habitat rotating about the spin axes 202 in respective rotation directions 122₁, 122₂, 122ₙ. The cargo 160 and cargo 170 may travel rim-to-rim between adjacent space habitats in the downhill orbital direction, exploiting the rim velocity of each space habitat to effect transfer without dedicated propulsion. In some embodiments, the receiving space habitat may capture arriving cargo 160 or cargo 170 and recover usable kinetic energy upon capture, and any cargo that misses a capture event may remain gravitationally bound to the system due to rim speeds maintained below the local escape velocity of the celestial body 110. In some embodiments, the cargo relay network formed by the co-orbiting space habitats 120₁ through 120ₙ may function as a propellant-free logistics system in which cargo pods travel as routed packets between space habitats, driving marginal transport cost toward zero for inter-habitat trade and resource distribution.

FIG. 2A is an exterior view 200A of the example space habitat 120₁, in accordance with some embodiments of the present disclosure. The exterior view 200A may show the puck-like exterior form produced by the spiral configuration of the space habitat 120₁, identifying the spin axis 202, an edge 210 at the outermost radial boundary, and a concentric arrangement of a town zone 220, a farm zone 230, and a forest zone 240 progressing inward from the edge 210 toward a low-gravity hub 250 proximate or adjacent to the spin axis 202. Gravity may increase continuously from approximately 0.25 g at the low-gravity hub 250 to approximately 0.975 g at the edge 210, with the town zone 220 occupying a gravity range of approximately 0.75 g to 1.0 g, the farm zone 230 occupying approximately 0.6 g to 0.75 g, and the forest zone 240 occupying approximately 0.3 g to 0.6 g. In some embodiments, the space habitat 120₁ may have a vessel thickness 204 measured parallel to the spin axis 202 that ranges from approximately one-third to two-thirds of the habitat radius, producing the puck-like mass distribution visible in the exterior view 200A.

FIG. 2B is a cutaway view 200B of the example space habitat 120₁, in accordance with some embodiments of the present disclosure. The cutaway view 200B may expose the interior gravity gradient, zone arrangement, and temperature profile as a function of radial position from the spin axis 202. Beginning at the spin axis 202, the low-gravity hub 250 may occupy the central region at approximately 0.25 g to 0.3 g. Moving outward from the low-gravity hub 250, the forest zone 240 may extend from approximately 0.3 g to 0.6 g with river temperature approximately 60° F., the farm zone 230 may extend from approximately 0.6 g to 0.75 g at approximately 70° F., and the town zone 220 may extend from approximately 0.75 g to 1.0 g near the edge 210 at approximately 80° F. In some embodiments, a convective circulation may form in which cooler near-surface air flows downhill along the river corridor, while warmer or moister return air flows uphill through an upper volume or ducted return path. For example, the temperature gradient across zones may drive natural buoyancy-driven air circulation, producing a prevailing breeze from the cooler forest zone 240 toward the warmer town zone 220 without mechanical fans.

FIG. 2C is a side cut-away view 200C of the example space habitat 120₁, in accordance with some embodiments of the present disclosure. The side cut-away view 200C may show the concentric zone arrangement relative to the spin axis 202, identifying the low-gravity hub 250 at the center, the forest zone 240 from approximately 0.3 g to 0.6 g, the farm zone 230 from approximately 0.6 g to 0.75 g, and the town zone 220 from approximately 0.75 g to 1.0 g at the edge 210. Zone boundaries may represent gradual transitions arising from the continuous gravity gradient rather than discrete physical separations. In some embodiments, the river system may include a plurality of river channels arranged helically and visible from the side cut-away view 200C, with adjacent river channels separated by islands configured to support one or more of housing, vegetation, pathways, or ecological features.

FIG. 2D is a cross-section view 200D of the example space habitat 120₁, in accordance with some embodiments of the present disclosure. The cross-section view 200D may show the layered structural and functional arrangement across the valley width, including a sky layer 260 providing diffuse overhead illumination, a light-emitting diode (LED) coolant loop 262 thermally coupled to a secondary, higher-temperature side-ejection radiator loop configured to receive and reject concentrated heat loads from LED lighting fixtures without burdening the primary river thermal cycle, a tensegrity cabling layer 266 providing structural support through hoop tension, and a rain filtration loop 268. A river segment 276 may run along the valley floor adjacent to a reservoir 274 configured to supply and receive water from the river segment 276. Housing or other living features 272 may be distributed along the deck surface. In some embodiments, the deck surface may incorporate a grade of approximately 5% directed toward the river segment 276 to channel surface runoff and precipitation for collection and recirculation.

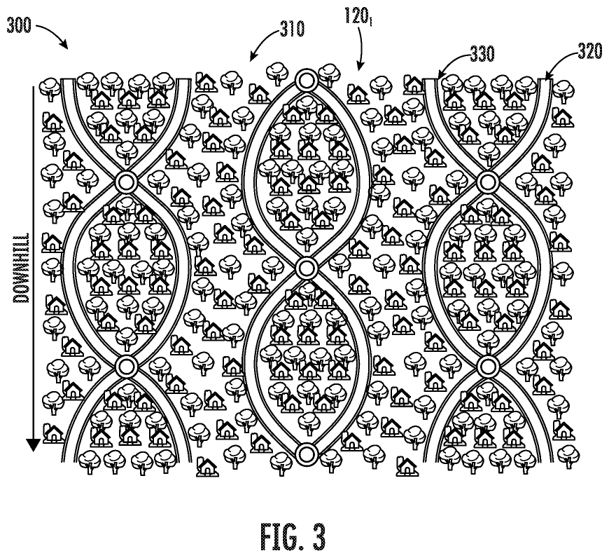

FIG. 3 is an example water circulation system 300 of the example space habitat 120₁, in accordance with some embodiments of the present disclosure. The water circulation system 300 may show the arrangement of housing or living features 310, a river system 320, and a pathway system 330 as they may appear from within the habitable valley of the space habitat 120₁. The river system 320 may run longitudinally along the valley floor in the downhill direction of the spiral, carrying water driven by the gravity gradient without mechanical pumping, at a substantially constant flow rate along the spiral configuration due to the geometric relationship between local gravity, river slope, and head pressure at each radial position. The pathway system 330 may run alongside the river system 320, providing pedestrian access along the length of the spiral, with housing features 310 disposed along the pathway system 330 and set back from the river system 320. In some embodiments, the pathway system 330 may include bridges crossing the river system 320 at intervals to connect housing features 310 on opposing banks, and one or more elevator systems may provide radial transport shortcuts between different gravity zones within the space habitat 120₁ without involving traversal of the full spiral path. In some embodiments, the river system 320 may also support a precipitation system configured to produce controlled rainfall sourced from the river system 320 and synchronized with the prevailing atmospheric circulation driven by the temperature gradient between the central region and the outer region of the space habitat 120₁.

### Example Operations for a Space Habitat

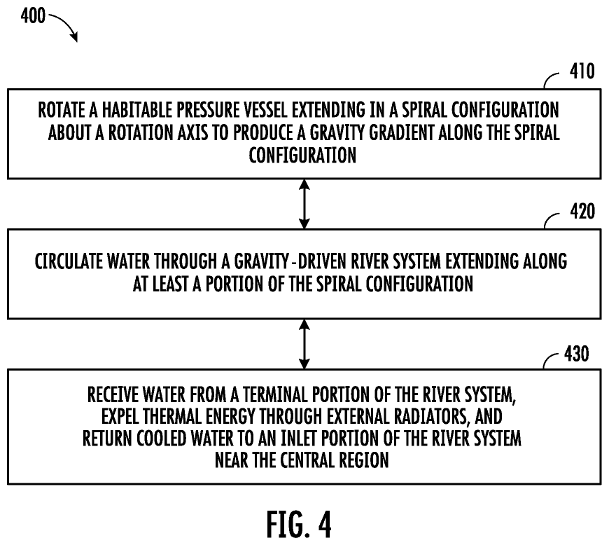

FIG. 4 is a flow diagram of example operations 400 for a space habitat, in accordance with some embodiments of the present disclosure. The method 400 may include a first operation 410 of rotating a habitable pressure vessel (e.g., space habitat 120₁, 120₂, 120ₙ, 140₁, 140₂, or 140ₙ) extending in a spiral configuration about a rotation axis (e.g., spin axis 202) to produce a gravity gradient along the spiral configuration. The method 400 may include a second operation 420 of circulating water through a gravity-driven river system (e.g., river system 320) extending along at least a portion of the spiral configuration. The method may include a third operation 430 of receiving water from a terminal portion of the river system, expelling thermal energy through external radiators, and returning cooled water to an inlet portion of the river system near the central region. In some cases, the third operation 430 may additionally include or be replaced by an operation that includes receiving, by a heat rejection system, water from a terminal portion of the river system; circulating the water through external radiators; and returning cooled water to an inlet portion of the river system near the central region. The operations 410, 420, and 430 may be performed continuously and concurrently during normal habitat operation, with the gravity gradient produced in operation 410 driving the passive water circulation of operation 420 without mechanical pumping.

### Engineering Issues Solved by Spiral Geometry

The Spiral geometry offers fundamental advantages over cylindrical prior art.

### Stability

By limiting, in some cases, the habitable valley width to no more than two-thirds of the habitat radius R, the spiral mass distribution resembles a puck. Its principal moments of inertia satisfy I_max >I_mid >I_min, keeping the rotation axis in a stable regime. The Spiral therefore exhibits passive inertial stability and resists Dzhanibekov-type tumbling without active control.

Scaling advantage

Unlike a stone arch or suspension bridge, which must thicken to carry its own increasing weight as the span grows, a spinning spiral of radius R behaves like a series of short arches of deck spacing R/σ: each coil is supported in hoop tension by its own tendons, so the added mass is the reduced R/σ term. In some embodiments, with σ=30, the difference is ~15 R² tonnes; hundreds of megatons at kilometer scales.

### Shielding

The spiral is largely self shielding. Most land area is deeply shadowed by successive spiral layers. Taking soil into account, under 0.5 m of water-equivalent hull shielding may be utilized to reduce 25 mSv/day to an Earthlike 5 μSv/day. In some embodiments, the spiral has 6 times less hull area than a cylinder of the same area. This difference is ~16.5 R² tonnes; again, hundreds of megatons at kilometer scales.

### Terrain

The spiral has wide ecology, over a spread of altitudes, air pressures, temperatures, and even gravity. The variation provides sensible zoning as well. A low-g forest zone from 0.3 g to 0.6 g, a mid-g farm zone from 0.6 g to 0.75 g, and an Earth-like town zone from 0.75 g to 1.0 g at the rim. The final “flat” 1.0 g cycle completes the circular rim, and can be ideal for filtration ponds.

Along the spiral length, we recommend all terrain be terraced for convenience, maintenance, and to resist erosion. Across the spiral cross section, for drainage and aesthetics we recommend a consistent 5% downhill grade toward the nearest river channel. A topsoil profile over a French-drain gravel substrate should ensure support for deep-rooted plants and trees, throughout.

### Hydrology

The river system is the heart of the spiral. A stunning emergent property of the geometry is constant river speed. At radius r, gravity ∝r, and slope ∝1/r, therefore head pressure (Darcy-Weisbach) and velocity are constant.

A smooth, gently flowing river can support vast ecology, resulting in a more robust and Earth-like ecosystem. We recommend 15 m wide helical (intersecting, wide serpentine) river channels (see diagram), fitted with vegetation trays, bollards (fake boulders) on outer banks, thalweg control vanes to stabilize bends, and finally, riffles (speedbumps) to set mean flow at the upper 0.75 m (2.5′) layer. Between riffles depth may increase to pools 2 m-3 m deep. For this arrangement, river speed is 2.7/√σ (Gauckler-Manning). This gives:
σ=15→0.70 m/s-1.6 mph
σ=20→0.60 m/s-1.3 mph
σ=25→0.54 m/s-1.2 mph
σ=30→0.50 m/s-1.1 mph

This sets the allowable operating range of the coiling constant σ. For σ=30 we can set the upper flow layer to a full 1.0 m and still achieve 0.60 m/s. Also note for g>0.3 and σ>15 the stability ratio is less than 1.6/√σ«1 (Froude), guaranteeing smooth, gentle flow.

Of note, the spiral terminates in a final flat 1.0 g rim cycle (the “delta”), which is excluded from river-length calculations used for velocity and float-time estimates. This flat section is intentionally configured for slower, meandering flow, deep ponds, and large-scale biological filtration prior to thermal rejection and recirculation.

### Cooling

The river system is also the primary environmental coolant loop. Radiator-cooled 15° C. water enters the top of the spiral and accumulates heat as it flows downhill to the rim. There, warm water is pumped back to the top through shadow-side radiators. The flux (width×depth×speed×ΔT) of the river system determines the amount of heat it can expel. This in turn determines the steady state heat limit of the spiral.

For total river width 10% (of valley width R/1.8) energy flux is 7.5 R/√σ MW. For a 2300 m radius habitat with σ=30, this exceeds 10 W/m². If we assume Earth-reasonable 500 m² per person that yields 1.5 W/m² for compost, plants, and animals, and steady 4.25 kW each for a half million people, and their homes.

A second, higher-temperature radiator loop should be coupled directly to outdoor LED lighting or industrial equipment, permitting those concentrated loads to be rejected to the nearest sidecap at 350 K-380 K without burdening the ecological river cycle.

### Airflow

The river temperature gradient naturally drives air circulation in the spiral. Cooler near-surface air preferentially occupies the valley floor and drifts downhill along the valley axis, while warmer, moister air returns uphill in the large volume well above ground level. As the river flows toward the outer rim, river temperature, air pressure, and local effective gravity all increase, strengthening buoyancy-driven exchange in the lower reaches. A consistent buoyancy/pressure-gradient scaling gives a river-level breeze that scales roughly as ³√ΔT. At ΔT=12 C we estimate a ~2.5 m/s (5.6 mph) downhill breeze at ground level, and ~5.0 m/s uphill breeze high above.

### Rain

The river system also fuels artificial rainfall. Natural airflow eliminates reliance on mechanical fans and creates an atmosphere continuously refreshed by forest processes. Rainfall systems can be synchronized with the prevailing wind to produce controlled precipitation bands for irrigation, humidity control, fire suppression, and air scrubbing.

### Oxygen

The forest is the lungs of the spiral. On Earth maximum productivity occurs in cloud forests near 2000m and 0.793atm. We want to set the upper reaches of the forest zone (0.4g) to this pressure. With a bit of calculation we can derive rim pressure ≈0.793 e^(R/20000 ).
1140 m →0.84 atm rim. Earth~1400 m/4500′
1610 m →0.86 atm rim. Earth~1200 m/4000′
2270 m →0.89 atm rim. Earth~900 m/3000′
3220 m →0.93 atm rim. Earth~600 m/1900′
4500 m →1.00 atm rim. Earth “sea level”.

### Transit

In addition to simply walking, we recommend two transport modes for getting around the spiral:

Radial Elevators: Multiple elevators or similar systems run radially through the structure, providing rapid “shortcut” access between different points along the spiral path and different gravity zones. Pneumatic elevators can be preferred for their efficiency in varying gravity and ability to navigate the spiral's geometry without heavy machinery.

Circumferential Transport: Systems along the spiral path (e.g., pathways, light rail) facilitate movement within a specific gravity zone.

### Assembly

Spiral components are two orders of magnitude smaller than a comparable cylinder. A cylinder acts as a continuous pressure vessel: its shell must carry global hoop stress, much like thousands of suspension bridges joined side by side, with kilometer-scale precision across the whole surface. The spiral instead relies on short, repeatable modules joined sequentially, where precision is local to each joint; defects remain isolated. Spin-up can be staged as coils are added, and (as noted above) the total hull and shielding mass is lighter by ~31.5 R² tonnes (R in meters), reducing handling and alignment demands.

### Example Deployments—Expanding our Biosphere

### Example Configuration:

The best place for spirals is generally around large moons with abundant resources. By arranging spirals in equatorial rings around these objects, we can create a functioning civilization. The innermost ring services mining transports from the moon below. The outermost ring supports intermoon transport, and new habitat construction. Rings in between can support millions of spirals, with desirable real estate many times that of Earth's total land area (see below). By keeping rim speeds below local escape velocity, these ring swarms also create a regenerative cargo relay network, with pods functioning as cargo packets routed rim-to-rim. Each transfer is propellant-free, returns usable energy on capture, and remains gravitationally bound if missed. The result is an insurable, volume priced cargo system that drives marginal transport cost toward zero, making inter-habitat trade routine and reliable, with no lost packages or passengers.

### Near-term Targets:

Moon—100 spirals in Lunar orbit. From this staging area, biosphere-stocked spirals can be shoved off to other locations with more abundant raw materials. The Moon itself actually has room for millions of spirals, but it has a dramatic lack of resources. Mass launched from Earth is extremely expensive, and importing asteroids to the Earth-Moon system is perilous.

Mars (cycler orbit)—2 spirals in Earth-Mars Aldrin-cycler orbit. Low-energy 2-year transit, and crucial gravity re-acclimation platform for crews returning to Earth from stays on the 0.38 g Martian surface.

Example locations:

Saturn's Moons Equatorial ring orbits around Titan and Dione, later Rhea and Iapetus. All by itself Titan has room for 1800 rings (millions) of spirals, with land area over 20 Earths. The Saturn system has low radiation, three-day lunar transits, and true Lockean abundance —millions of years of raw materials (water, methane, carbon, and volatiles). 6 year transfer orbit to send the first spirals.

Uranus'Moons—200 equatorial rings around moons Ariel and Umbriel. 400 around Titania and Oberon. Total land area is approximately 5 Earths. The Uranus system has low radiation, three-day lunar transits, and is (very likely) resource-rich. For initial seed spirals, the 16 year transfer orbit from Earth to Uranus will no doubt feel like our first voyage to another solar system.

Other possible targets:

Ceres (Asteroid)—250 rings of spirals, with land area approximately 0.5 Earths. Ceres is isolated, but it is moon-like, resource-rich, and relatively closeby. 1.5 year transfer orbit to send the first seed spirals.

Jupiter—The Jupiter system is roasting with lethal radiation. In principle, Callisto has room for 1700 rings, and millions of spirals. In practice, radiation risk and lack of accessible resources make it unlikely.

Neptune—400 equatorial rings around Triton. Resource-rich with low radiation. Land area is approximately 2 Earths. However, the 32 year transfer orbit from Earth to Neptune may be too much to bear. Of note, transfer orbits from Saturn or Uranus would take even longer. Slingshot methods would be faster, but then orbital insertion becomes impossible.

### BIBLIOGRAPHY

[1]-Potočnik, Hermann (as Noordung) . Das Problem der Befahrung des

Weltraums-der Raketen-Motor. Berlin: Richard Carl Schmidt and Co., 1929. (English translation: The Problem of Space Travel: The Rocket Motor. NASA SP-4026, NASA History Series, 1995.) [2]-Bernal, John Desmond. The World, the Flesh and the Devil: An

Enquiry into the Future of the Three Enemies of the Rational Soul. London: Kegan Paul, Trench, Trubner and Co., 1929. (Reprint: Indiana University Press, 1969.) [3]-Von Braun, Wernher; Ley, Willy; Ryan, Cornelius, ed. “Man Will Conquer Space Soon!” Collier's Magazine, Mar. 22, 1952 and subsequent issues (1952-1954). (Collected in: von Braun, Wernher et al. Across the Space Frontier. New York: Viking Press, 1952.) [4]-Clarke, Arthur C. Rendezvous with Rama. New York: Harcourt Brace

Jovanovich, 1973. (See also: Clarke, Arthur C. “Extra-Terrestrial Relays.” Wireless World, October 1945, pp. 305-308.) [5]-O'Neill, Gerard K. “The Colonization of Space.” Physics Today 27, no. 9 (September 1974): 32-40.[6]-Johnson, Richard D., and Charles Holbrow, eds. Space Settlements: A

Design Study. NASA SP- 413. Washington, D.C.: NASA, 1977. (Report of the 1975 NASA Ames/Stanford Summer Study, with major contributions by Gerard K. O'Neill and colleagues.) [7]-O'Neill, Gerard K. The High Frontier: Human Colonies in Space. New

York: William Morrow, 1976. (Updated editions 1989, 2000.) [8]-Globus, Al; Hall, Theodore; and Jochim, Daniel. “Kalpana One: A New Orbital Space Colony Design.” AIAA-2006-7516. Presented at AIAA Space 2006, San Jose, CA, September 2006. Revised 2007.[9]-Janhunen, Pekka. “Natural Illumination Solutions for Rotating Space Settlements.” arXiv preprint arXiv: 1806.09808, 2018.[10]-Cellucci, Benedetto; Jenett, Benjamin; and Cheung, Kenneth. “Digital Cellular Solid Pressure Vessels.” arXiv preprint arXiv: 1703.00044, 2017.[11]-McKendree, Thomas L. “Implications of Molecular Nanotechnology Technical Performance Parameters on Previously Defined Space System Architectures.” Nanotechnology 11, no. 2(2000 ): 89-104. (Commonly cited as the origin of the “McKendree Cylinder” concept.)

### Additional Considerations

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the inventions herein are not to be limited to the specific embodiments disclosed and that modifications and other embodiments are intended to be included within the scope of the inventions. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the inventions herein. In this regard, for example, different combinations of elements and/or functions than those explicitly described above are also contemplated within the scope of the inventions. Although specific terms are employed herein, they are used in a generic and descriptive sense only and not for purposes of limitation.

What is claimed is:

1. A space habitat comprising:
a continuously habitable pressure vessel extending in a spiral configuration about a rotation axis, wherein rotation of the space habitat around the rotation axis produces a gravity gradient along the spiral configuration from a central region of the vessel to an outer region of the vessel;
a circulating gravity-driven river system extending along at least a portion of the spiral configuration; and
a heat rejection system configured to receive water from a terminal portion of the river system, circulate the water through external radiators, and return cooled water to an inlet portion of the river system.

2. The space habitat of claim 1, wherein a local slope of the river system varies approximately inversely with local distance from the rotation axis, thereby offsetting a radial variation in local artificial gravity, resulting in near constant head pressure and substantially uniform river speed throughout the spiral configuration.

3. The space habitat of claim 1, wherein the gravity gradient increases along the spiral configuration from the central region to between 0.9 g and 1.1 g at the outer region.

4. The space habitat of claim 1, wherein:
the vessel has a thickness measured parallel to the rotation axis and a radius measured from the rotation axis to an outermost point of the vessel; and
the thickness ranges from ⅓ of the radius to ⅔ of the radius.

5. The space habitat of claim 1, wherein the external radiators are positioned on an exterior surface of the space habitat configured for shadow-side heat rejection.

6. The space habitat of claim 1, wherein the river system comprises a plurality of river channels arranged helically.

7. The space habitat of claim 6, wherein the plurality of river channels are separated by islands configured to support one or more of housing, vegetation, pathways, or ecological features.

8. The space habitat of claim 1, further comprising a water reclamation segment located near the outer region and configured to treat the water from the river system before the water enters the heat rejection system.

9. The space habitat of claim 1, further comprising a precipitation system configured to produce controlled rainfall sourced from the river system.

10. The space habitat of claim 1, further comprising one or more elevator systems providing radial transport shortcuts through the space habitat between different points along the spiral configuration.

11. The space habitat of claim 1, wherein the vessel is divided into functional zones based on local gravity levels including a forest zone having a gravity level between 0.3 g and 0.6 g, a farm zone having a gravity level between 0.6 g and 0.75 g, and a town zone having a gravity level between 0.75 g and 1.0 g.

12. The space habitat of claim 1, wherein lighting is provided by LED fixtures configured to transfer heat to a secondary, higher-temperature side-ejection radiator loop.

13. A space habitat system comprising:
a plurality of space habitats co-orbiting a celestial body, each space habitat of the plurality of space habitats comprising:
a continuously habitable pressure vessel extending in a spiral configuration about a rotation axis, wherein rotation of the space habitat around the rotation axis produces a gravity gradient along the spiral configuration from a central region of the vessel to an outer region of the vessel;
a circulating gravity-driven river system extending along at least a portion of the spiral configuration; and
a heat rejection system configured to receive water from a terminal portion of the river system, circulate the water through external radiators, and return cooled water to an inlet portion of the river system.

14. The space habitat system of claim 13, wherein the plurality of space habitats form a propellant-free cargo relay network.

15. A rotating space habitat comprising:
a spiral configuration generating a smooth gradient of artificial gravity between a central core and an outer rim;
a river system flowing along a length of the spiral configuration, configured for ecosystem support and acting as a primary medium for capturing and transporting internal habitat heat; and
a radiator system thermally coupled to the river system, configured to receive heated water from near the outer rim, reject captured heat to space, and return cooled water to the river system near the central core.

16. The space habitat of claim 15, wherein the spiral configuration completes approximately 12 to 24 revolutions, establishing an artificial gravity gradient ranging from 0.3 g at the central core to 1.0 g at the outer rim.

17. The space habitat of claim 15, further comprising a habitable valley having a width that is constrained to less than or equal to a radius/1.5, ensuring a thin-puck inertial distribution that is passively stable against tumbling.

18. The space habitat of claim 15, further comprising a precipitation system configured to produce controlled rainfall synchronized with prevailing atmospheric circulation.

19. The space habitat of claim 15, further comprising one or more elevator systems providing radial transport shortcuts through the rotating space habitat between different points along the spiral configuration.

20. The space habitat of claim 15, wherein a structure of the rotating space habitat is divided into functional zones based on local gravity levels including a forest zone having a gravity level between 0.3 g and 0.6 g, a farm zone having a gravity level between 0.6 g and 0.75 g, and a town zone having a gravity level between 0.75 g and 1.0 g.

21. The space habitat of claim 15, wherein lighting is provided by LED fixtures, transferring heat to a secondary, higher-temperature side-ejection radiator loop.
